(19) United States
(12) Patent Application Publication
(10) Pub. No.: US 2021/0410100 A1
(43) Pub. Date: Dec. 30, 2021

(54) Method and Apparatus for Location Based Services for Enterprise Networks

(71) Applicant: Celona, Inc., Cupertino, CA (US)

(72) Inventor: Srinivasan Balasubramanian, San Diego, CA (US)

(21) Appl. No.: 17/359,049

(22) Filed: Jun. 25, 2021

Related U.S. Application Data
(60) Provisional application No. 63/044,212, filed on Jun. 25, 2020.

(51) Int. Cl. H04W 64/00; G01S 5/02; H04W 4/021

(52) U.S. Cl. CPC H04W 64/003; H04W 4/021; G01S 5/0284

(57) ABSTRACT

Methods and apparatus for location based services for Enterprise Networks are described. UE position location determination methods and apparatus are described for use within Enterprise Networks (ENs) and methods for enhancing and improving communications between the ENs and Mobile Network Operators (MNOs) for transmission of UE positioning information determined locally by the EN network are described. In one embodiment, the EN performs UE location positioning operations locally, including trilateration of the UEs operating within the EN. The EN uses inherent knowledge regarding the different types of EN cells deployed within the EN when performing the UE positioning determinations. The EN also accounts for errors in EN eNB deployments, inaccuracies in eNB positioning, and other EN cell characteristics when performing the UE location determinations. The EN communicates UE positioning information and EN-specific contextual information using an enhanced LPPa communications protocol and an enhanced MOCN gateway between the EN Core network and the MNO Core network.

### CLAIM OF PRIORITY TO PREVIOUSLY FILED PROVISIONAL APPLICATION—INCORPORATION BY REFERENCE

This application claims priority under 35 USC section 111 (b) and under 35 USC section 119 (e), to earlier-filed provisional application No. 63/044,212 filed Jun. 25, 2020, entitled “Method and Apparatus for Location Based Services for Enterprise Networks” (ATTY. DOCKET NO. CEL-027-PROV); and the contents of this earlier-filed provisional application (App. No. 63/044,212) are hereby incorporated by reference herein as if set forth in full.

### BACKGROUND

### (1) Technical Field

The disclosed method and apparatus relate generally to systems for locating communication equipment within a communication network, and more particularly to locating a communication device within an enterprise network.

### (2) Background

Location Based Services (LBS) are primarily driven by two major requirements: (1) emergency services; and (2) commercial applications. With regard to emergency services, the most significant driver is the federal communications commission's (FCC's) E911 mandate in the US. The E911 mandate requires the location of a phone with a predetermined accuracy to be provided when an emergency call is made. For commercial applications, a wide variety of applications and services are provided, such as maps and location-based advertising. Many of these need fast and accurate determination of the position of a mobile user equipment (UE). Some of the key metrics include: (1) positioning quality of service (QoS), (2) Time to First Fix (TTFF), and (3) accuracy of the determined location.

Some of the techniques used in mobile handsets include: (1) Enhanced Cell ID (ECID), (2) Assisted Global Navigation Satellite Systems (A-GNSS), and (3) Observed Time Difference of Arrival (OTDOA). In LTE networks, the positioning architectures include control plane techniques that use LTE Position Protocol (LPP). In addition, user plane techniques include Secure User Plane Location (SUPL 2.0) with radio resource location services protocol (RRLP). In some cases, the user plane protocol for enabling LBS and E911 on some networks includes support for techniques such as WiFi positioning.

Cell ID (CID) positioning is a network-based technique that can be used to estimate the position of the UE quickly. CID has very low accuracy; typically equating to the size of the cell a UE is camped upon (which may be in the order of kilometers). In the simplest case, UE is estimated to be located at the position of the base station upon which it is camped. Enhanced Cell ID (ECID) is an improvement over CID. Round Trip Time (RTT) between the base station and the UE is used to estimate the distance to the UE. The RTT is determined by analyzing Timing Advance (TA) measurements, either from the eNodeB or by directly querying the UE. The eNodeB tracks two types of TA measurements. The first type is measured by summing the eNodeB and the UE receive-transmit time differences. The second type is measured by the eNodeB during a UE Random Access procedure. In addition, the network can use the Angle of Arrival (AoA) of signals from the UE to provide directional information. The AoA is measured based on uplink transmissions from the UE and the known configuration of the eNodeB antenna array having a plurality of receive elements. The received UE signal between successive antenna elements is typically phase-shifted by a measurable value. The degree of this phase shift depends on the AoA, the antenna element spacing, and the carrier frequency. By measuring the phase shift and using known eNodeB characteristics to determine the antenna element spacing and the carrier frequency, the AoA can be determined. Typical uplink signals used in this measurement are Sounding Reference Signals (SRS) or Demodulation Reference Signals (DM-RS). The main sources of error in ECID are receive timing uncertainty (which affects the RTT calculation) and multipath reflections. Typically, these result in an accuracy of 150 m or more.

In global navigation satellite systems (GNSS), the GNSS receiver in a mobile device is solely responsible for receiving satellite signals and computing the location of the mobile device. The receiver needs to acquire satellite signals through a search process. The receiver must lock onto at least four satellites in order to compute a 3-D position. The acquisition process is demanding in terms of battery and processing power, and TTFF can be long due to the need to acquire a minimum of four satellites.

In assisted GNSS (A-GNSS) a significantly improvement is achieved over standalone GNSS. In a typical A-GNSS implementation, the GNSS capability of the UE is augmented by data provided by the network, commonly known as “Assistance Data”. Assistance data includes information the mobile GNSS receiver typically receives from the satellites. By providing this information to the mobile GNSS receiver through another communication link to the mobile GNSS receiver, satellite signal acquisition can be accelerated and made more efficient. The final position is then calculated by either the UE or the network and shared with third parties (such as emergency PSAPs1). Accordingly, A-GNSS speeds up positioning performance, improves receiver sensitivity and helps to conserve battery power. A-GNSS works well outdoors and in scenarios where a reasonably good view of the sky is available. However, performance is generally poor in environments in which a view of the sky is obscured and/or conditions in which there is “multipath interference”, such as indoors and in dense urban settings. Currently, two global systems are fully operational—the global positioning satellite (GPS) system and GLONASS (GLObal NAvigation Satellite System). While mobile receivers have traditionally supported positioning using A-GPS alone, it is possible to use both satellite systems simultaneously to acquire a position. The advantage of this technique is to effectively increase the number of satellites available for signal acquisition. This improves the performance in environments in which the sky may be obscured, as may be the case in cities. Assistance data for both GPS and GLONASS satellites (as well as Galileo and QZSS when these systems are fully operational) can be provided by an LTE network. The typical accuracy for these systems is 10−50 m.

In Observed Time Difference of Arrival (OTDOA) systems, CRS (Cell Reference Signals) based OTDOA techniques use a method similar in principle to the GNSS position calculation methodology. The UE measures the time differences for a plurality of signals on the downlink (i.e., signals received by the UE from two or more base stations). Using the known position of the base stations and the measured time differences of arrival from each, it is then possible to calculate the position of the UE. The difference in the arrival time measured for CRS arriving from the serving cell and one or more neighboring cells is known as Reference Signal Time Difference (RSTD). In order to calculate the position of the UE, the network needs the positions of the eNodeB transmit antennas and the transmission timing of each cell. Attaining this information can be challenging if the eNodeBs are asynchronous. One of the biggest challenges facing LTE OTDOA is the need to measure neighboring Cell-RS accurately. PRS (position reference signal) is introduced in Release 9 of the 3GPP Location Standards to solve this issue. These special reference signals assist in measuring neighboring cell signals by increasing the CRS energy. The PRS is periodically transmitted along with the cell specific reference signal (RS) in groups of consecutive downlink sub frames.

In a fully synchronized network, these positioning sub frames overlap, allowing for reduced inter-cell interference. In the case in which the PRS patterns in two neighboring cells overlap, the network may mute the transmissions to improve signal acquisition. The network can also provide Assistance Data to the UE to aid the UE's acquisition of the PRS. This data usually consists of relative eNodeB transmit timing differences (in the case of a synchronous network), search window length, and expected PRS patterns of surrounding cells. OTDOA can be used as a fallback technology when GNSS is not available and in attempts to attain positioning information indoors and in environments without a clear view of the sky. These techniques provide an accuracy of approximately 50-200 m.

OTDOA and A-GNSS may be used together in a “hybrid” mode. Since the fundamental positioning calculation approach is the same, a combination of satellites and base station locations can be used in the position calculation function. In this technique, the UE measures the RSTD for at least one pair of cells and satellite signals and returns the measurements to the network. The network is responsible for analyzing the measurements and calculating a position. This hybrid mode typically provides better accuracy than OTDOA positioning alone. Furthermore, it can provide improved positioning accuracy in challenging environments. Uplink TDOA (UTDOA) is an uplink alternative method to OTDOA. UTDOA is being standardized for Release 11 of the LTE Position Location Standard. UTDOA utilizes uplink time of arrival (ToA) or TDOA measurements performed at multiple receiving points. Measurements are based on Sounding Reference Signals (SRSs).

In addition to the above techniques, the following methods are commonly known, do not require additional standardization and are also included in LTE Release 9. Radio frequency (RF) fingerprinting is a method of finding a user position by mapping RF measurements obtained from the UE onto an RF map, where the map is typically based on detailed RF predictions or site surveying results. Assisted ECID (AECID) is a method that enhances the performance of RF fingerprinting by extending the number of radio properties that are used and where at least CIDs, timing advance, RSTD, and AoA may be used in addition to received signal strengths. Furthermore, corresponding databases are automatically built up by collecting high-precision OTDOA and A-GNSS positions, tagged with measured radio properties.

LPP is used for exchanging positioning information between the UE and the LTE network. LPP is similar to protocols such as RRC, RRLP, and IS-801 and is used both in Control Plane and User Plane (enabled by SUPL 2.0). Each LPP session comprises one or more LPP transactions, each session performing a single operation (e.g., capability exchange, assistance data transfer, or location information transfer). A key entity within the core network that handles positioning is the Evolved Serving Mobile Location Center (E-SMLC). The E-SMLC is responsible for providing accurate assistance data and accurately calculating the position of the UE. The SUPL 2.0 protocol can be deployed across different networks (2G/3G/4G/5G) to provide one common user plane protocol. Initial LTE deployments can be performed using RRLP. A more sophisticated deployment can be accomplished with the introduction of LPP. RRLP only supports A-GNSS; delivery of LTE ECID and OTDOA information is not supported. However, SUPL 2.0 has native support for sending information about the serving LTE and neighboring cells.

Positioning over LTE is enabled by LPP, which is designed to support the positioning methods (OTDOA, ECID, A-GNSS) covered previously. LPP call flows are procedure based, where each procedure has a single objective (e.g., delivery of Assistance Data). The main functions of LPP are to provide the E-SMLC with the positioning capabilities of the UE to transport Assistance Data from the E-SMLC to the UE. In addition, the LPP provides the E-SMLC with coordinate position information or UE measured signals. The LPP also reports errors during the positioning session. LPP can support “hybrid” positioning such as OTDOA+A-GNSS.

In the case of network-based positioning techniques, the E-SMLC may require information from the eNodeB (such as receive-transmit time difference measurements for supporting ECID). A protocol called the LPP-Annex, or LTE Positioning Protocol annex (LPPa) is used to transport this information. OMA has proposed extensions to LPP, referred to as “LPPe” that can be used to carry more data and thus improve existing positioning techniques, as well enable new methods (such as WLAN positioning). LPPe also includes additional information to enhance existing positioning techniques, as well as providing a bearer for new positioning methods (such as sensor positioning and Short Range Node positioning). LPPe is primarily considered a User Plane positioning enabler.

For user plane positioning over LTE, SUPL uses existing control plane protocols (such as RRLP, IS-801 and LPP), rather than introducing a new method to package and transport Assistance Data. An entity called the SUPL Location Platform (SLP) handles SUPL messaging, and typically interfaces with the E-SMLC for obtaining Assistance Data. SUPL messages are routed over the data link via the LTE P-GW and the S-GW entities. SUPL 2.0 enables a complex feature set that is pertinent to mobile applications, including area-based triggering, periodic reporting, and batch reporting. SUPL 2.0 also features support for emergency positioning over the data link, and support for major positioning technologies (including multi-location technologies such as WiFi positioning). The primary positioning enabler in SUPL 2.0 is an underlying control plane protocol (such as RRLP or LPP). This implies that SUPL 2.0 can be used over any network, as long as the SLP and SMLC are able to interface and agree upon a common positioning protocol. SUPL 2.0 supports reporting of cell information for all major cellular wireless technologies as well as wireless LAN access point information. This feature, termed multi location ID, allows a location server to process several different types of measurements in order to calculate a more accurate position. In the future, SUPL 3.0 is expected to support extensions to the LPP protocol (LPPe).

With regard to emergency services, SUPL 2.0 introduces an entity known as the Emergency SLP (E-SLP). The E-SLP co-ordinates with the IP Multimedia Subsystem (IMS) in LTE networks to enable positioning for an emergency call. The E-SLP functionality can be added to an existing SLP used by the network. When an emergency call is in process, the IMS coordinates the call with a Network Initiated Location Request from the E-SLP. Emergency positioning can override user notification and privacy settings and receive priority over all non-emergency SUPL sessions.

It should be noted that terminal-assisted positioning is technically superior to terminal-based positioning, since it can make use of terminal measurements together with the available knowledge about the radio environment accumulated in the network, while keeping UE-complexity low. Terminal-assisted positioning also has advantages over standalone network-based positioning, which relies on network measurements and network knowledge, is constrained by the maximum terminal power and cannot benefit from measurements at the actual user location.

In summary, CID is the fastest available measurement-free positioning method that relies on the cell ID of the serving cell (information that is typically available) and the location associated with that cell. However, the accuracy of CID depends on the size of the serving cell. A-GNSS, including A-GPS, is the most accurate positioning method in satellite-friendly environments. The most accurate terrestrial method is OTDOA, which is based on downlink measurements of positioning reference signals transmitted by radio nodes such as eNodeBs or beacon devices. OTDOA and A-GNSS provide highly accurate positioning in most parts of a cellular network and for most typical environments. UTDOA performance may approach that of OTDOA in some deployment scenarios that are not UL-coverage-limited, assuming the use of enhanced UL receivers. To improve positioning in challenging radio environments, these methods can complement one another, for example, with hybrid positioning, proximity location and new positioning methods in the middle accuracy range, including AoA, RF fingerprinting and AECID.

Note that the AECID method utilizes a wider set of measurements than the RF fingerprinting method. This includes, for example, timing measurements. That results in AECID being significantly less subject to environment limitations. It should also be noted that in the future, as networks become denser, the role of proximity methods will become important.

Accordingly, there is presently a desire for accurate position location information that can assist in locating UEs within an enterprise communications network.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of the basic components of a communications network having position location capability.

FIG. 2A is a block diagram of a UE Positioning Architecture in an LTE communication system.

FIG. 2B is a block diagram showing the UE Positioning Architecture of FIG. 2A wherein the EN Core Network is in communication with an MNO Core Network via a Multi-Operator Core Network (MOCN) gateway.

FIG. 3 is an illustration showing cell footprints that may exist in an Enterprise Network with each cell having different sizes, shapes and configurations; and FIG. 3 is also used to show how trilateration might be implemented in an Enterprise Network.

FIG. 4 is an illustration showing how trilateration techniques may be used by the present method and apparatus.

FIG. 5 is an illustration showing a measured location range relative to each eNB cell within an Enterprise Network.

FIG. 6 shows an exemplary OTDOA technique in implementing LBS in Enterprise Networks.

FIG. 7 is an illustration of a location estimation of a CBSD (or EN eNB) deployed within an Enterprise Network (EN).

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

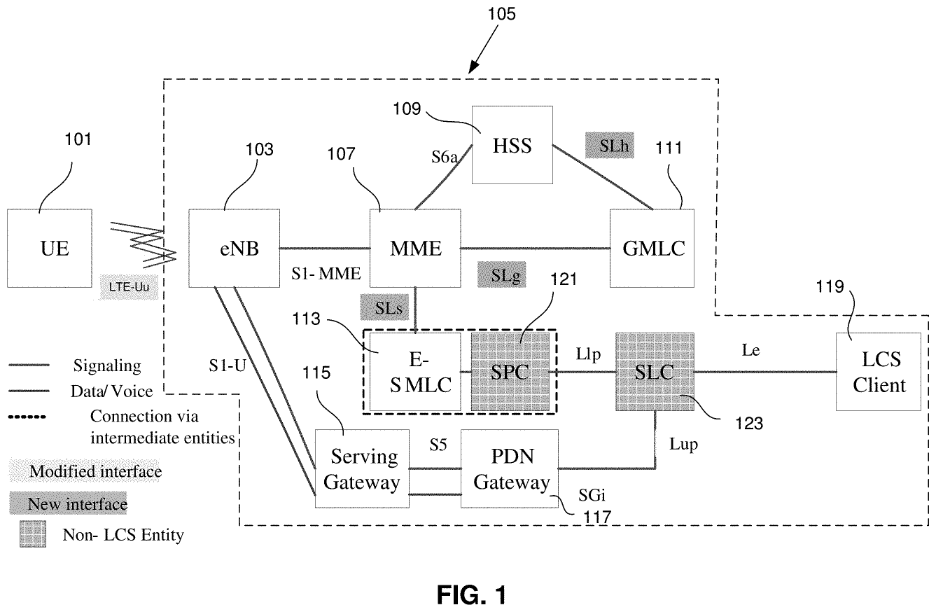

FIG. 1 is an illustration of the basic components of a communications network having position location capability. A wireless device operated by a user, commonly referred to as a “User Equipment” (UE) 101, is shown to be in wireless communication with an eNodeB (also referred to herein as an “eNB”) 103 of a communications network 105. In addition to the eNB 103, the communications network 105 comprises an MME (Mobility Management Entity) 107, an HSS (Home Subscriber Server) 109, a GMLC (Gateway Mobile Location Center) 111, an E-SMLC (Serving Mobile Location Center) 113, a serving gateway (SGW) 115, a PDN (Packet Data Network) gateway 117, a LCS (LoCation Services) Client 119, an SPC 121 and an SLC 123. In some embodiments of the present methods and apparatus, the communications network 105 can exist both in the macro network operated by Mobile Network Operators (MNOs) and also as a communications network operating within the Enterprise Networks (ENs). That is, the communications network 105 shown in FIG. 1 can exist within a network operated by an MNO, and an analogous communications network 105′ (very similar if not identical to that shown in FIG. 1) can exist and be operated within an EN.

As is well known, the MME 107 is the main control node that processes the NAS signaling between the UE and the core network which is responsible for idle-mode UE tracking and paging procedure as well as bearer establishment and release.

Data and voice signals are transmitted between the UE 101 and the eNB 103. The eNB 103 communicates data and voice packets to the SGW 115 over an S1-U interface. The SWG passes packets back and forth with the PDN gateway 117. In addition, signaling is communicated over an S1-C interface to the SWG 115, which communicates signaling to the PDN gateway 117. The PDN gateway 117 can also communicate signaling packets with the SLC 123 over an Lᵤₚ interface.

As shown in FIG. 1, the eNB 103 is also coupled via an S1-MME interface to the MME 107. The MME 107 can communicate with the HSS 109 via an S6a interface to allow for authentication of the UE 101. In accordance with some embodiments of the presently disclosed methods and apparatus, an SL_{S} Interface is defined between the MME 107 and the E-SMLC 113. In addition, an SL_{g} interface is defined between the MME 107 and the GMLC 111. In addition, an SLₕ interface is defined between the HSS 109 and the GMLC 111.

As described in greater detail below, in some embodiments of the present methods and apparatus, the LPPa protocol interface is supported, modified, and enhanced, thereby allowing the MNO E-SMLC 113 to query the EN eNB 103 to obtain measurements as dictated by Measurement Request Messages (MRMs) generated by the MNO E-SMLC 113 (when the communications network 105 of FIG. 1 comprises an MNO communication network). In addition, the LPPa protocol can be extended to include the GPS location of the EN eNB 103 as well. In accordance with some exemplary embodiments of the present methods and apparatus, the reports transmitted from the EN eNB 103 to the E-SMLC 113 via the LPPa protocol will additionally include the following items in the messages: (they will, for example, include E-CID measurement reports, OTDOA information responses, UTDOA information responses, etc.). The reports will also include the eNB GPS location and the cell type associated with the eNB. The cell types may include those created using “omni-directional” antenna eNBs, directional antenna eNBs, the cell sizes in terms of CATA/CATB cell types and the allowed Tx power as allowed by the SAS entity for the eNB's operation.

In addition, an E-SMLC in the enterprise network (EN) (analogous to the E-SMLC 113 of the MNO communications network 105 shown in FIG. 1) can be provided in the enterprise network (EN). In such embodiments, this EN E-SMLC allows the location of UEs to be determined locally (i.e., determined locally within the EN campus using location services capabilities of the EN). In addition, the EN E-SMLC (analogous to the MNO E-SMLC 113 of FIG. 1) can, in some embodiments, serve as an interface node to the MNO core. Furthermore, the public safely access point (PSAP) can be integrated with Enterprise E-SMLC. Alternatively, the Enterprise E-SMLC can work directly with the MNO E-SMLC 113 (via MNO MME-to-EN MME interoperability). Furthermore, GPS locations for the eNBs 103 deployed within an enterprise network (EN) campus can be provided to the Mobile Network Operators (MNOs) as part of the deployment of the EN campus.

In some embodiments, location determinations can initially be made using a single Cell-ID location. However, the GPS location of the eNB 103 should be provided to the E-SMLC 113. Later implementations can be built out to support full measurement approaches.

User Plane SUPL UE Positioning Determination Described with Reference to the Communications Network of FIG. 1

The presently described methods and apparatus for Location Based Services for Enterprise Networks uses what is referred to as the “Secure User Plane Location” (“SUPL”) architecture for mobile devices in a wireless network. The SUPL architecture works in the “User Plane”, or “U-Plane,” to provide Location Based Services without adversely impacting the Control plane elements of the wireless network. Before the SUPL architecture was used for UE positioning and location determination purposes, the Control plane was used in positioning architectures in LTE networks. Under this Control plane, there existed a location determination mechanism wherein the UEs 101 communicated via a radio interface (using the Control plane) using radio signaling messages that informed the eNB 103 of their positioning measurement information. However, disadvantageously, this Control plane positioning technique required additional designs and redesigns to be performed for each type of mobile device technology as they developed over time. Disadvantageously, these designs and redesigns could not be performed generically and could not take advantage of scaling approaches and other techniques, such as Wi-Fi, that could have been used to perform or assist in the UE location positioning techniques. In contrast, by using the User plane protocol such as SUPL, the radio measurements and any other location determination functions are controlled by the MNO Core, including the E-SMLC 113 functions that exist, and also including the other location services capabilities of the MNO Core network 105. In this manner, other functions that are established beyond the MNO MME 107 are available for the purposes of determining positioning locations of the UEs 101. In accordance with the presently disclosed methods and apparatus, these services are all performed within the User plane and therefore do not interfere with Control plane elements and system performance. Consequently, the UE location determination can be performed without radio signaling, without hop-to-hop messaging informing the PDN gateway 117 what actions to take, and without having to instruct the Serving gateway 115 as to what actions to take. By performing UE location determination in the User Plane, all of these previously required functions are no longer required. Instead, the MNO Core network (such as the communications network 105 of FIG. 1) is able to use its location services functions to instruct the UE 101 as to what entities to measure and what measurements to make in order for it to determine the location of the UEs.

The measurements returned by the UE 101 could very well be GPS coordinate information. It could, in some embodiments, include assisted-GPS information. In some embodiments, the MNO MME 107 instructs the UE 101 to make certain measurements and report the information that it obtains. In some embodiments, the positioning information is based on radio signature information, the reference radio signals that the UE 101 measures, an “angle of arrival” that the UE 101 measures, etc. All of this information can be communicated to the MNO Core location services functions in the MNO communications circuit 105 of FIG. 1.

The description set forth above applies to performing UE location determination using the MNO Core LCS functions. The one aspect that the MNO communications network 105 has in common with its analogous EN communications network 105′ is the eNB 103. The one common device that links these two communication networks together is the eNB 103. The location of the eNB 103 is a known quantity. The location information of the eNB 103 must be communicated to the MNO Core communications network 105 so that it can be used in a table of information regarding the locations of the eNBs it is in communication with, in addition to other information. Additionally, the locations of the Citizens Broadband Radio Service Device (“CBSDs”) (i.e., the eNBs within the enterprise networks (ENs)), must also be included in a table of information maintained by the EN.

As described below in more detail, in order to determine a UE location using trilateration techniques, at least three eNBs are required (and, of course, the position locations of these three eNBs must also be known). Therefore, to perform trilateration upon a selected UE within an EN, at least three EN eNBs must be identified and their location information must be known. However, as described in greater detail hereinbelow, the positioning locations of the CBSDs within the EN have inherent inaccuracies associated with them. According to FCC specifications, the CBSDs must be positioned within a horizontal accuracy of plus or minus 50 meters. They must be positioned within a vertical accuracy (or, elevation accuracy) of plus or minus 3 meters. Unless these inherent location inaccuracies are taken into account, UE location determination procedures will lead to incorrect results. Each location of the eNBs (or CBSDs) in the EN are populated in a table or database in both the EN and the MNO. The footprint of an EN eNB (or CBSD) cell can be equal to or less than 50 meters for an indoor EN eNB. Consequently, significant errors in UE location positioning determination can result if these inaccuracies are not taken into account by the UE location determination methods and apparatus.

Presently, the exchange of UE positioning information between the MNO communications network (MNO Core) and the EN communications network (EN Core) is essentially a downlink-centric communications path and is limited in the information that is exchanged between the MNO Core and the EN Core. There exists a passageway of communication to exchange UE positioning information between the EN Core and the MNO Core that currently is not being fully utilized. Essentially, the MNO issues MRMs to the ENs to instruct the UEs located on the EN campus to provide radio signal strength measurements to the MNO Core.

Additional UE positioning information which is known by, and only known by, the EN, is not currently being communicated to the MNO Core. Uplink-centric and EN-specific UE location information, that is best understood by and better determined locally by the EN, is not being currently being utilized in existing communication systems. The EN reports back to the MNO the measured UE radio signal strength measurements only, essentially GPS coordinate positioning information, and no other EN-specific contextual information. Currently the EN provides simply cellID information to the MNO. The EN eNB is capable of receiving signal information and it is able to determine the angle of arrival, and it is able to perform uplink OTDOA time difference of arrival measurements. It is also able to locally determine the UEs position and communicate all of this information via the LPPa protocol and communications link. Using the LPPa protocol, as modified and enhanced in accordance with the presently disclosed methods and apparatus, the EN eNB can communicate more and improved UE positioning information to the MNO MME 107 of the MNO communications network 105 of FIG. 1.

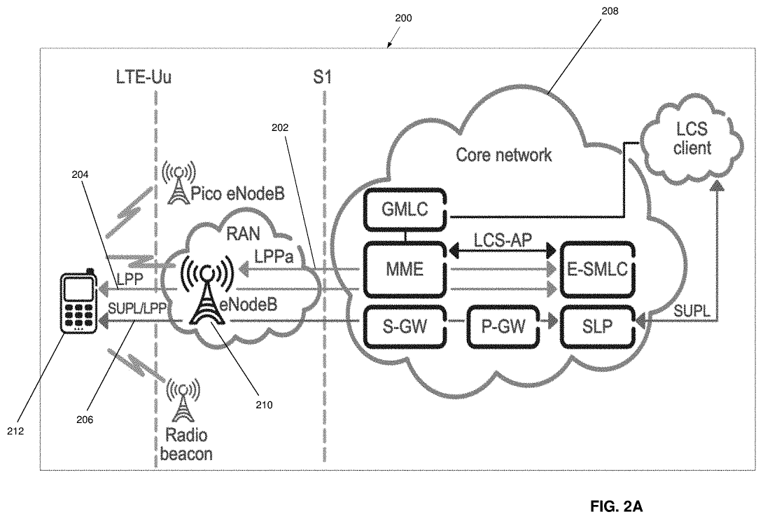

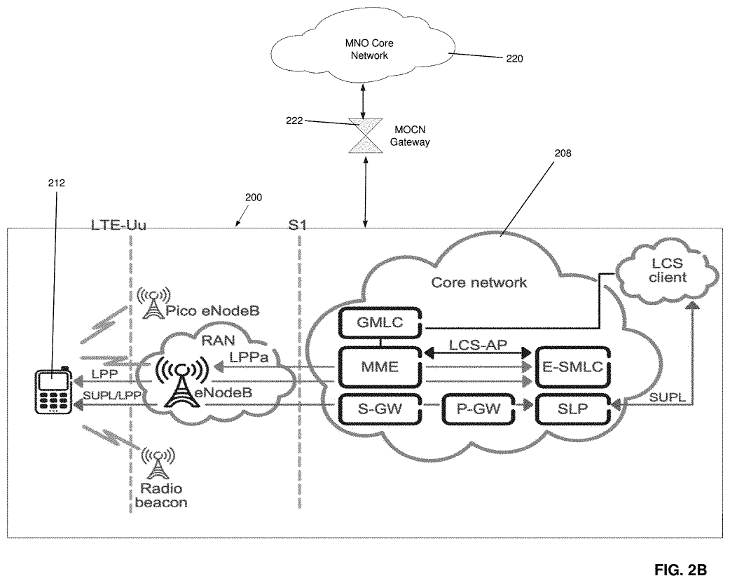

Consequently, one of the advantages of the presently disclosed methods and apparatus for location based services for Enterprise Networks (ENs) is to improve the UE positioning functionality that the EN is able to accomplish and communicate back to the MNO. The footprints of the ENs cells are relatively small, and the best UE positioning solution is likely achievable using a Bluetooth solution. However, even assuming that a Bluetooth-based technique may provide a better UE location positioning solution, UE positioning can be improved locally within the EN using cell-based positioning approaches such as trilateration and OTDOA techniques. This is especially true because the EN designers understand and have knowledge of what the EN cells look like (what types of transmitters are used within the EN cells and what the cell footprint shapes look like), and how they are configured. The EN designers also know better than do the MNO network designers where the potential UE location errors exist, what causes these errors, etc. Consequently, the presently disclosed methods and apparatus for location based services for Enterprise Networks (ENs) advantageously uses cell-based methods and techniques locally within the EN campus and communications network. The UE location positioning information is then communicated to the MNOs using the LPPa signaling protocols and via the eNBs. The UE positioning architecture used in LTE communications is shown in FIGS. 2A and 2B and is now described with reference to those figures.

FIG. 2A is a block diagram of a UE Positioning Architecture 200 in an LTE communication system. It is assumed for the purposes of this disclosure that the positioning architecture shown in FIG. 2A resides within an Enterprise Network (EN) campus. The Positioning Architecture includes the EN Core Network 208, which is in communication with at least one eNodeB (eNB) 210, which is likewise in communication with at least one UE 212. As shown in FIG. 2A, the EN Core Network's MME communicates with the eNodeB (eNB) 210 via the LPPa communication protocol 202. The eNB 210 communicates with the UE 212 via the LPP communication protocol 204 and via the SUPL/LPP communication protocol 206. The EN MME communicates positioning information via the LPPa communication protocols 202. The LPPa communication protocol 202 is used to pass UE location data between the EN MME and the eNB, and between the EN MME and the EN E-SMLC.

If the UE 212 is camped on the EN eNB 210 and does not have access to the MNO, then the EN (and specifically the EN E-SMLC and EN MME) activates the location services function for the UE 212. However, in most cases the UE 212 has access to both the EN Core network 208 and the MNO Core network (shown as 220 in FIG. 2B).

FIG. 2B is a block diagram showing the UE Positioning Architecture 200 of FIG. 2A wherein the EN Core Network 208 is in communication with an MNO Core Network 220 via a Multi-Operator Core Network (MOCN) gateway 222. In this scenario, the MNO Core network 220 can activate its location functionality and information to perform the UE location determination function for the UE 212. In some embodiments, the MNO Core Network 220 is essentially identical to the EN Core Network 208 and includes many if not all of the same components. For example, as shown in FIG. 2B, both core networks 208, 220 include at least the following blocks: a GMLC block (similar to the GMLC 111 shown in the communications network 105 of FIG. 1), an MME block (similar to the MME 107 shown in the communications network 105 of FIG. 1), an S-GW gateway (similar to Serving Gateway 115 shown in the communications network 105 of FIG. 1), a P-GW block, an E-SMLC block (similar to the E-SMLC 113 shown in the communications network 105 of FIG. 1), an SLP block, and an LCS client (similar to LCS Client 119 shown in the communications network 105 of FIG. 1). As shown in FIG. 2B, the LCS Client (both the LCS Client shown in the EN Core network 208 and the LCS Client not explicitly shown in the MNO Core Network 220) communicates with the SLP block via the SUPL architecture for mobile devices in a wireless network which, as described above, operates in the User plane. In some embodiments of the present methods and apparatus, the UE 212 acts as a conduit for the EN to communicate with the MNO Core network.

It should be noted with reference to the UE Positioning Architectures of FIGS. 2A and 2B that no matter how the UE positioning determination is made (whether locally within the EN and by the EN Core Network), or by the MNO, the MNO Core Network 220 can always instruct the UE 212 to perform a cell-based location determination based on the macro eNBs it is capable of measuring in the MNO network. Nothing in the presently described methods and apparatus prohibits the MNO from instructing the UE to perform these measurements of the macro eNBs it can measure. Said differently, nothing in the presently described location based services for ENs methods and apparatus prevents the UE's position determination to be made by using the MNO and the MNO's UE location determination techniques. The UE can be instructed to in a sense, “walk away” from the EN for a period of time in order to obtain positioning information using the MNOs UE location determination capabilities. The UE can then be instructed to return to using the location determination techniques set forth herein. Such use of the MNO for UE location determination would be initiated by the LPP protocol, which would instruct the UE to look for pilots occurring on a certain frequency. The UE would be instructed to measure those pilots on that frequency and report back to the MNO as to what the UE measures on those frequency channels.

Challenges Presented and Solutions Provided by the Present Method and Apparatus when Performing UE Location Determination in EN Networks

Due to the nature of UEs, the MNO Core Network, and the EN communications network deployment, capabilities, and characteristics, several challenges arise when attempting to accurately determine the location of a UE when it is within an EN campus. Some of these challenges are set forth in the description below, together with solutions to these challenges that are provided by the presently disclosed methods and apparatus for location based services for Enterprise Networks.

A single Cell-ID and its associated GPS location may not be sufficient to meet the Positioning QoS. This challenge/limitation exists in existing deployments of Enterprise Networks (ENs). One possible solution is to use a single node deployment in the EN. However, as noted above, in order to perform some type of trilateration technique on the UE a minimum of three eNBs are required.

Another challenge presented when performing UE location determination functions within an EN is that GPS signal reception within the EN campus is typically very poor, or even more likely, non-existent. This is because the UEs are typically indoors when operating in the EN campus. In some embodiments, a GPS repeater may be placed in a building. In some such embodiments, the repeater is simply a blind repeater, but will allow for GPS location from satellites to be represented indoors for a given building. For larger buildings, multiple repeaters with indoor drops can be placed in locations corresponding to the closest location to an outdoor tap of the GPS location to mitigate against poor GPS signal penetration within the building.

Another challenge is related to lateral and vertical positioning requirements. Lateral positioning while being a requirement, indoor positioning is required to be augmented with vertical positioning within a building with z-axis floor level information. Providing room level information is desirable but it is not mandated. will be good but is not a mandate). The solution to this challenge as provided in some embodiments of the present methods and apparatus is set forth below in more detail.

Additionally, MRM (Measurement Request Messages) for emergency services may need to be more extensive to allow for improved location determination of the UE. This is particularly true when the emergency is associated with the location of a wing or a floor of the EN campus. Improved UE location determination in these cases can become critical to the safety and health of the UE user. The solution to this challenge as provided in some embodiments of the present methods and apparatus is set forth below in more detail.

Non-Uniform EN Cell Footprints—Also, unlike the macro cells (or MNO cells), that generally have uniform footprints, the footprints of the EN cells do not have uniform footprints. This is due to the fact that the EN uses many different types of eNBs, each having different transmit power levels; they may be indoor or outdoor eNBs, and they may be omni-directional or directional. This results in ENs having EN cell footprints of different shapes and sizes. The EN E-SMLC algorithm (performed, for example, by the EN E-SMLC 113 of FIG. 1) used to perform the UE location determination functions therefore needs to adapt to different Tx power level settings of the indoor and outdoor eNBs when performing UE positioning estimations. Non-uniform EN cell footprints are accounted for by the present methods and apparatus for location based services in EN networks when determining the UE locations. This solution provided by the present method and apparatus is described in greater detail below.

In order to meet the challenges set forth above when performing UE location determination within EN Networks, several possible solutions can be attempted. Integration of the EN eNB GPS locations with the MNOs can be provided in one or more of the following ways:
1. The eNB GPS locations can be provided to the MNOs as part of the deployment on the EN campus.
2. Supporting and enhancing the LPPa communications protocol and have the E-SMLC query the EN eNB to get the desired measurements and extend it to include the GPS location of the EN eNB as well.
3. Defining an E-SMLC in the EN (Enterprise Network), and allowing for the location of the UE to be determined locally (i.e., within the EN), and providing this as an interface node to the MNO core (such as, for example, the MNO Core Network 220 of FIG. 2B). PSAP integration with the Enterprise (EN) E-SMLC or Enterprise-SMLC interworking with the MNO E-SMLC will be required.

Solutions set forth in points 2. and 3. above are provided by the present methods and apparatus. UE location determination is presently performed by the macro network, by the MNOs, and not locally within the ENs. The MNO determines a UE's location via trilateration and other location determination techniques and provides the UE's location information to those that request or need it. However, as noted above, the EN designers and deployment engineers are in a far better position (as compared with the MNOs) to account for the challenges presented when determining UE position locations of a UE that is operating within the EN. The EN location services can also function to not only provide more accurate GPS positioning information, but it can also provide EN-specific contextual information along with the location information. This is because the EN has information that is specific to the deployment of the EN within the EN campus. However, even if a location information service is built within the EN and performed by the EN, the GPS coordinate information of the UE is not sufficient in some cases.

For example, simply providing GPS coordinate information of a UE is not necessarily sufficient or desirable, especially in emergency situations. However, if a location information service is built within the enterprise campus or within the EN, it is desirable that it provides additional EN-specific contextual information as well as GPS coordinate information about the UE. For example, the location information could contain EN-specific contextual information about the specific building that the UE is located in (for example, in building “Q314-H”). This adds completely new and additional location information regarding the UE's location and may be essential when used by emergency nodes. Further, it may be essential to inform emergency workers and those that require the information that the UE is on a certain floor of building Q, for example, and that building Q has “x” number of floors, etc., and that “floor 314” means that the UE is on the third floor, 14th room on the left, that the UE is on the West Wing, and that “H” means that the UE is on a certain side of building Q as opposed to another side of building Q, etc. The EN knows how to obtain and determine this very EN-specific contextual UE location information because the EN's deployers have a map to perform such a detailed level of location identification functionality.

Currently there is no interface that exists that is defined in a protocol for the EN to communicate this type of GPS coordinate information and the additional EN campus-specific contextual information described above to the MNO. No interface or communication protocol between the EN Core and the MNO Core currently exists to allow for communication of both the GPS positioning information of the UEs and the EN campus-specific contextual information to the MNO and to the world beyond the EN campus. The present methods and apparatus allow the communication of this type of UE location information between the MNOs and the ENs. Specifically, the EN E-SMLC (similar to the E-SMLC 113 of FIG. 1) is defined and designed to allow for the UE location determination to be performed locally within the EN, and this is provided as an interface node to the MNO Core Network. One way of solving this is to allow for the E-SMLC to query the enterprise network to allow for the UE location to be determined locally and provide that as an interface node to the MNO core with an interface with the EN core. PSAP integration with Enterprise-E-SMLC or Enterprise-E-SMLC networking with MNO-E-SMLC is necessary to achieve this in some embodiments.

Measurement Request Messages (MRM) Coordination with the MNO E-SMLC

In some embodiments, MRM coordination with the MNO E-SMLC is desirable. The UE MRM requests are typically initiated from the MNO MME. In some embodiments, the MNO S1-MME interface is enhanced to allow for the MNO MME to provide a request to the EN eNB selecting the relevant neighbors that the UE needs to perform measurements on. The MOCN gateway 222 (FIG. 2B) between the MNO Core Network 220 and the EN Core Network 208 is also enhanced to facilitate this function. The MNO will not know which relevant neighboring eNBs (in the EN) of the UE to select it to perform measurements on. In addition, corresponding enhancements to report the RTSP/AoA in the LPPa communications protocol are required. The MNO S1-MME interface is enhanced in some embodiments to include E-CID measurement initiation requests, UTDOA information requests, etc. The UTDOA information request messages are enhanced for the MNO E-SMLC to not provide the cells where the measurements are to be made and indicate that the “enterprise network” should make that determination and include the selected cell for performing the measurements in the report/response messages sent from the eNB to the MNO E-SMLC. In this embodiment, the MNO does not instruct which eNBs that the UE should obtain measurements from. This is performed internally within the EN.

In accordance with the presently disclosed methods and apparatus, measurement request messages (MRMs) coming from the MNO MME (in the macro network) are allowed to potentially be modified and affected by the Enterprise Network (EN) when the UEs operate within the EN.

A neutral UE, one that is camped on a CBSD of an EN, is able to tunnel all the way back to the MME of the MNO Core network (such as the MNO Core network 220 of FIG. 2B). Such a UE device currently does not use the MME of the EN Core network for local location determination purposes. In such a case, the MRMs are transmitted to the neutral UE by the MNO and it is for the MNO Core network to perform the UE positioning determination.

However, for the reasons set forth above, the MNO typically is not the best entity or in the best position to make location positioning determinations for UEs that are operating within the EN. For the reasons set forth above, the EN MME (similar to the MME 107 of FIG. 1) and the EN Core network (such as the EN Core network 208 of FIGS. 2A and 2B) are in a much better position to perform the UE location determination (for a UE operating within the EN campus) than is the MNO Core network. In order to allow for such local EN UE location determination to occur, the S1-MME interface between the MNO MME (for example, the MME 107 of FIG. 1) and the EN eNB (for example, the eNB 103 of FIG. 1) is modified and enhanced to allow the MNO MME to initiate improved (better) MRM requests for measurements. In essence, the modification of the S1-MME interface between the EN eNB and the MNO MME informs the MNO MME how to initiate and form the MRMs transmitted to the EN when the UE operates within the UE campus. The enhanced S1-MME interface assists the MNO MME in forming the MRMs to allow the EN to perform location determination of UEs locally within the EN campus. In some embodiments, the MRMs are actually formed in response to assistance and information provided to the MNO MME (by the EN). The MRMs initiated by the MNO MMEs are affected by and assisted by the EN when the UE is operating within the EN campus.

In some embodiments, possible implementation scenarios to achieve MRM coordination with the MNO E-SMLC are set forth as follows:

Modify the S1-MME interface in the MNO circuit between the EN eNB and the MNO MME as described above.

For the MNO MMEs, it is helpful for its eNBs to advise the MNO MME on the “best triggers” to provide it in terms of what types of measurements should be provided. This is because the eNB can communicate with its local MME and indicate that a particular UE requires its location to be determined, and also determine what information should be communicated to its associated macro (i.e., MNO) MME to perform that location determination, and then to perform it.

Another possible implementation approach is to use inter-MME communications between the MNO MME and the EN MME. For a variety of reasons, this is very difficult to implement and therefore it is very unlikely to be implemented.

The likely implementation will be for a communication to be transmitted via the MNO eNB to the EN eNB, coming back to the macro eNB (MNO eNB), then instructing the MNO MME. The MNO MME then generates MRMs and thereby instructs the EN CBSD to perform the UE location determination or measurement.

In some embodiments, the key approach is to enhance and modify the S1-MME interface in the MNO between the EN eNB and the MNO MME. The MOCN gateway 222 between the EN Core network 208 and the MNO Core network 220 (shown in FIG. 2B) is also modified and enhanced to allow the EN Core network 208 to perform UE location determination when the UE operates within the EN campus.

### Solution for Determining UE Location Information in an EN Having Non-Uniform Cell Footprints

As briefly noted above, dealing with the potential for non-uniformity of cell sizes within the EN will be difficult for the MNO-E-SMLC to accommodate and process. In some embodiments, this can be mitigated by having a local Enterprise-E-SMLC and establishing connections with the MNO MME/SLC/E-SMLC. An enhancement to the LPPa protocol in some embodiments is made to allow the cell-size (in terms of a pilot signal transmit power/linear distance) to be included for the E-SLMC to proportionally perform trilateration operations. The required enhancements are as set forth above with regard to enhancing the LPPa to allow the transmission of reports including E-CID measurement reports, OTDOA information responses, UTDOA information responses, the eNB GPS location and the cell type information. Macro/MNO cell-based information can be used as well with inter-frequency measurements enabled by the enterprise eNB. This is possible when the MNO is still in coverage.

The MNO E-SMLC (such as the E-SMLC 113 of FIG. 1) will review signal trends and will understand what the behavior is within the EN to a certain degree. One of the difficulties associated with the cell non-uniformity in the EN stems from the fact that different types of eNBs can be used in deployment of the EN. Different types of cells may also be deployed within the EN. For example, “CAT-A” cells and “CAT-B” cells may be deployed within the EN. CAT-A cells can transmit up to 30 dBm, while CAT-B cells can transmit up to 47 dBm. The location determination tasks for the MNO, and specifically for the MNO E-SMLC (113 of FIG. 1), become even more complicated when the “Spectrum Allocation Server” (SAS) entity demands that the power levels transmitted within the EN cells be diminished (i.e., “throttled back”), or increased. The SAS can demand that the full power allocation to an EN cell be diminished or increased. This power level allocation can be temporary. It does need to be a permanent power allocation block or diminishment of the power allocation allowed to a selected cell.

Given this however, the footprint of the EN cells and the measurement of the transmit signals within the EN cells by a UE will very much depend on the transmit signal strengths of the reference signals which are being transmitted within the EN cells. If the SAS instructs the CBSD to throttle the transmit signal levels down or to increase them this will significantly affect the signal strengths measured by UEs within that cell. This throttling of transmit signal strengths happens dynamically between the SAS and the CBSD of the EN. This changing in the transmit power signal strengths occurs dynamically based on the SAS entity that communicates with is a CBSD. This signal strength increase or decrease as demanded by the SAS entity is known only at the enterprise network (known only within the EN). Information about the SAS entity's transmit level controls within the EN cells are not known by the MNO, the MNO MME, or MNO E-SMLC. Therefore, for these reasons and the other challenges set forth above, the EN is the best entity to use to perform UE location determination when the UE operates within the EN campus.

There are a few viable approaches or techniques that can be used to overcome the MNO's difficulties in obtaining the location of the UEs when they are operating within the EN campus. These approaches can be used to overcome some of the challenges described above and to accommodate the non-uniformity of EN cell sizes and the varying signal strengths within each EN cell.

One approach is to support a local Enterprise E-SMLC and establish connections between the MNO MME/SLC/E-SMLC to support the transfer of UE positioning information to the MNO Core network (such as the MNO Core Network 220 of FIG. 2B). Given that there are several complexities challenging the determination of the UE location, one approach is to deploy a local E-SMLC (i.e., the EN E-SMLC such as the E-SMLC 113 of FIG. 1) that knows about the complexities and details of the EN campus to perform the location services function for the MNO E-SMLC. That way the EN E-SMLC performs all of the UE location determination locally and provides this information to the MNO.

Another approach is to enhance the LPPa protocol to allow for including the cell size information (in terms of the pilot transmit power/and linear distance) for the MNO E-SLMC to proportionally perform the trilateration operation. This approach would provide to the MNO not only the GPS positioning information, but it would also include information about the cell size and the transmit power level changes within the EN cells. This would all be provided to the MNO in order for the MNO to take all of this information into account when making the UE location positioning determination. Specifically, this information can be provided to the MNO by the EN using the LPPa communications protocol and specifically provided to the MNO E-SMLC for its use in performing the UE location determination operations.

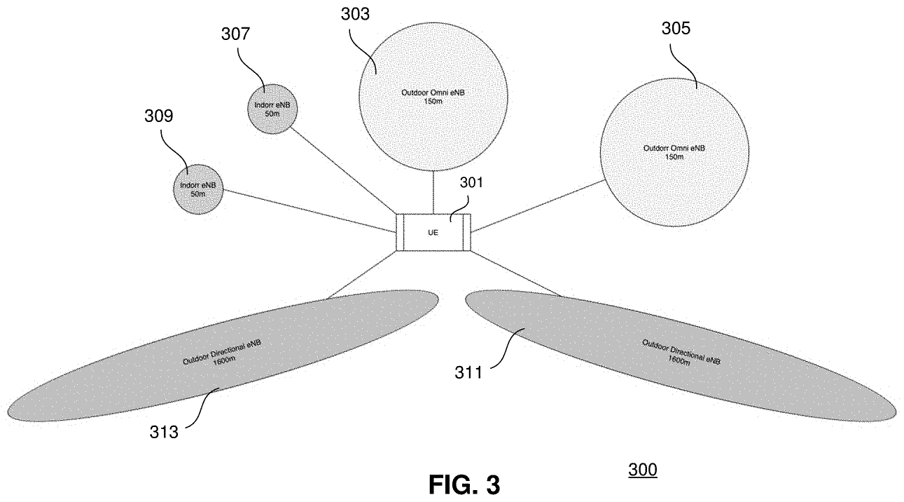

The difficulty presented by this approach is that it is very much complicated by the fact that the CBSDs of the EN use different types of eNBs with differently shaped footprints as shown in FIG. 3. It's very difficult to know precisely where the UE is within each footprint due to the different shapes of the footprints and due to the signal strengths received by the UEs when present within those footprints. For example, when the UE operates within the ellipsoid shaped cell footprints 307 of FIG. 3 it can appear to be in two different potential locations within the ellipsoid.

Communicating all of this information about the shape of all of the different eNBs (CBSDs) and the variances in their transmit power allowance is not currently accommodated by any of the E-SMLCs in the MNO network. Nor is this information communicated to the MNO E-SMLCs via the LPPa interface. So, one aspect of the present methods and apparatus is to modify this LPPa interface/protocol to assist the MNO E-SMLC with EN specific information regarding the EN cells.

As noted briefly above, the FCC standards require that devices must determine their location to an accuracy of plus or minus 50 meters in the horizontal direction, and to an accuracy of plus or minus 3 meters in a vertical (elevational) direction. This implies that there could be an inherent error in the location reporting even with a single small cell based on the error in the reported location of the CBSD. Therefore, trilateration is required for indoor cells to allow for tighter reporting regions and to keep the location error under the 50 meters (plus or minus) accuracy requirement, in the horizontal direction.

FIG. 3 is an illustration showing cell footprints that may exist in an Enterprise Network 300, with each cell potentially having different sizes, shapes and configurations, and FIG. 3 is also used to show how trilateration might be implemented in the Enterprise Network 300. As shown in FIG. 3, there EN cells defined by eNBs (or CBSDs) having directional beams which, in some cases, can be deployed as a flat panel antenna. The angle of the transmission beam can be as small 67.5 degrees. It will typically can be 90 degrees. These type of eNB transmissions result in the ellipsoid shaped cell footprints 311 and 313 which are created by outdoor directional eNBs capable of transmitting signals up to 1600 meters. The angles of the eNB transmission beams can be 180 degrees, or even 360 degrees, in which case the cell is referred to as an “Omni” directional cell (created by an “Omni directional eNB”). Two outdoor omni-directional eNBs and their circularly-shaped footprints are shown as cells 303 and 305 in FIG. 3. Two indoor omni-directional eNBs and their circularly-shaped footprints are shown as cells 307 and 309 in FIG. 3.

At any given point in time, the UE can be in the footprint of one of the several cells shown in FIG. 3. The eNBs for these cells can be of different types including but not limited to the following: CATA/CATB, antenna type of omni/directional (45 degrees, 60 degrees, 90 degrees, 180 degrees), horizontal versus azimuth MIMO, mac transmit power level, etc. When performing trilateration, these aspects of the cells shown in FIG. 3 must be taken into account in assessing the Euclidian distance of the UE from the cell locations. Therefore, the trilateration mathematical equations used to determine the location of the UE must take information about the differently shaped, sized, and power transmission capable cells into account in order to accurately obtain the UE's location within the EN.

As can be observed by reviewing the cell footprints of the EN 300 of FIG. 3, each of the cell footprints can have a different shape and structure within the EN. Furthermore, the actual physical location of each eNB (that is, where the CBSD is “dropped” within the cell) can vary and be prone to location errors. As described above, these problems are addressed by the present methods and apparatus modifying and enhancing the LPPa communication protocol such that the E-SMLC queries each eNB to get the measurements it requires and extends this to include the GPS coordinate positioning locations of the eNBs. These problems may also be addressed by defining an E-SMLC in the EN (an EN E-SMLC, such as the E-SMLC 113 of FIG. 1) and allowing the location of a UE to be determined locally within the EN. This is then provided an interface node to the MNO core, and specifically to the MNO E-SMLC. PSAP integration with the Enterprise E-SMLC or Enterprise E-SMLC interworking with the MNO E-SMLC will be required.

Another possible solution, albeit a commercially remote approach, is to extract the UE positioning information (and cell size, transmit power information, etc.), from the Spectrum Allocation Server (SAS) server. The SAS has a tremendous amount of information about the EN and the CBSDs located within the EN. If the MNO were modified to communicate with the SAS entity, the cell size and other information related to the EN might be able to be communicated to the MNO for it to make the UE location determination correctly. However, there are two obstacles to solving the location determination problem using this approach: (1) the MNOs cannot easily accommodate the necessary revisions/modifications to allow for this solution, and (2) enterprise-specific privacy information would be exposed to the MNO. It is unlikely that an EN owner would want its privacy information made available to the MNO. Therefore, due to the difficulty in modifying the MNO to accommodate this information, and due to the privacy concerns on the part of the EN owner, this possible solution is very unlikely to be commercially viable.

In some embodiments, triggers are provided for positioning to be initiated from the E-SMLC. In some embodiments, User plane is used rather than control plane. In some embodiments, cell-ID provides positioning with indoor base stations. In some such embodiments, the MNO retains the GPS position of all the enterprise eNBs. Assisted Global Navigation Satellite Systems (A-GNSS) are used to provide positioning for most outdoor scenarios. Accordingly, GPS coverage can be attained in high rises, canyons. OTDOA can be used in indoor and outdoor scenarios. In such embodiments, the MNO retains the GPS position of all the enterprise eNBs. In some such embodiments, inter-frequency scans are performed with the enterprise deployment. In some embodiments, it may be hard to make measurements across indoor and outdoor eNBs for trilateration and the MRM may restrict itself to a single type for position measurement. Nonetheless, trilateration may be used even for indoor cell to allow for a tighter reporting region to keep the error under 50 m.

### Trilateration in Enterprise Networks

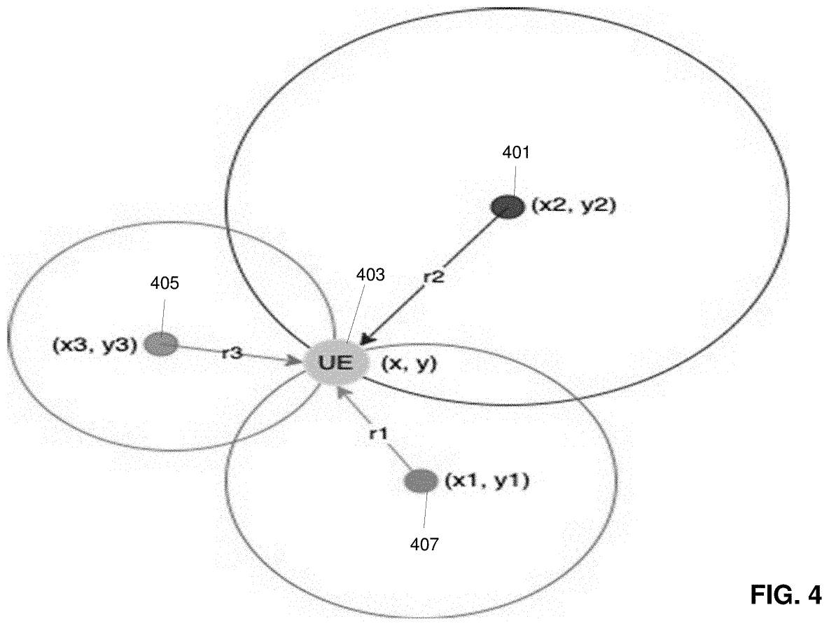

FIG. 4 is an illustration of the manner in which trilateration might be implemented in an Enterprise Network. Signals from a plurality of outdoor omni eNBs 401 are received by a UE 403. In addition, signals from the UE 403 are received by the eNBs 401. In addition, a plurality of indoor eNBs 405 transmit to and receive signals from the UE 403. In addition, there may be one or more outdoor directional eNBs 407 that are transmitting signals to and receiving signals from the UE 403.

Trilateration techniques used by the present method and apparatus are described with reference to FIG. 4. As shown in the example of FIG. 4, the UE 403 is in communications with three eNBs 401, 405 and 407. The x, y positions of the eNBs 401, 405 and 407 are known (to some extent). The radial distances r1 (radial distance between the eNB 407 and the UE 403), r2 (radial distance between the eNB 401 and the UE 403), and r3 (radial distance between the eNB 405 and the UE 403) can be determined based on the signals received by the eNBs 401, 405 and 407 from the UE 403. The radial distance estimations are, in some embodiments, based on the signal strength (reference signal received power—“RSRP”) and cell type (or eNB type) (indoor eNB, outdoor omni eNB, or outdoor directional eNB). Errors in the radial distance estimations can result from errors in the CBSD GPS location positions. In some cases, there can be a plus or minus 50 meter potential error in the radial distance estimations based upon the error in the configuration of the GPS location of the cell.

The following equations are used to determine the x, y position of the UE 403 using a trilateration technique.

Distance Equations:

(x−x₁)²+(y−y₁)²=r₁²;(x−x₂)²+(y−y₂)²=r₂²;(x−x₃)²+(y−y₃)²=r₃².

Simultaneous Equations for x and y:

(−2x₁+2x₂)x+(−2y₁+2y₂)y=r₁²−r₂²−x₁²+x₂²−y₁²+y₂²;

(−2x₂+2x₃)x+(−2y₂+2y₃)y=r₂²−r₃²−x₂²+x₃²−y₂²+y₃².

Simplifying the representation as follows:

$$Ax + By = C ;$$

$$Dx + Ey = F . ; Compute x and y$$

$$x = \frac{CE - FB}{EA - BD}$$

$$y = \frac{CD - AF}{BD - AE}$$

Trilateration Procedure with Misconfigurations—As noted above, errors can be introduced into the x, y computation due to errors in the CBSD location configuration, and also due to the fact that the radial distance estimations are based on RSRP values and not based on a fixed radial distance from the CBSD. In accordance with some embodiments of the present method and apparatus, trilateration procedures can be performed to account for these errors. The cell size for each pilot signal that the signal strength is reported on is an available quantity. Error in radial distances for a given cell can be bounded relative to reports from other cells thereby adjusting for potential errors in their configuration subject to the measured range from each cell. The ranges for xᵢ and yᵢ can be computed as follows:

x_{i_min}=xᵢ−Err_{max_config};

y_{i_min}=yᵢ−Err_{max_config};

x_{i_max}=xᵢ+50;y_{i_max}=yᵢ+50.

Trilateration can be performed for (x, y) with the combination of parameters set forth above, subject to the range for (x, y):

xₘᵢₙ=min((x_{i_min}−rᵢ) [symbol] i) (1)

xₘₐₓ=min((x_{i_max}−rᵢ) [symbol] i) (2)

yₘᵢₙ=min((y_{i_min}−rᵢ) [symbol] i) (3)

yₘₐₓ=min((y_{i_max}−rᵢ) [symbol] i) (4)

Allowing for more than three pilots will allow for further restriction of the area of the UE location.

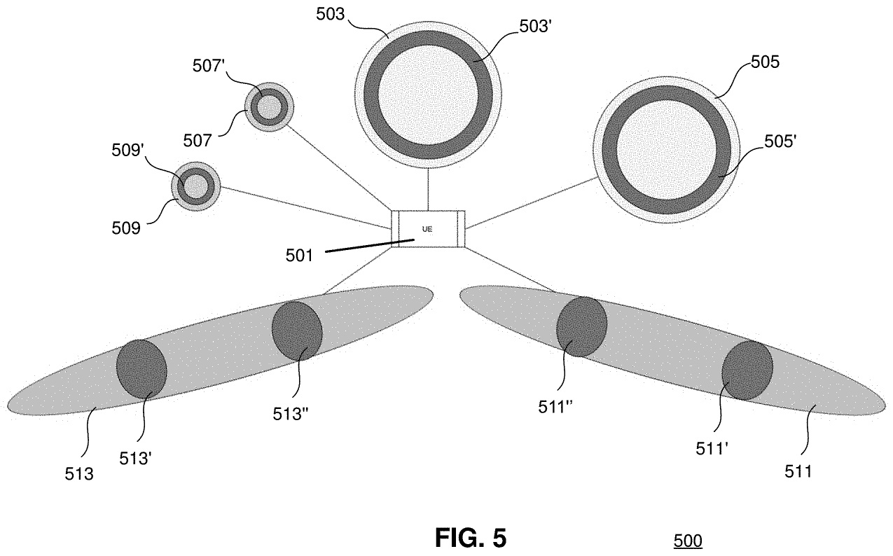

FIG. 5 is an illustration showing a measured location range to a UE 501 relative to each eNB cell within an Enterprise Network 500. When instructed to do so, the UE 501 reports the signal strength information of the various EN cells that it is instructed to provide signal strength measurement information on. For example, as shown in FIG. 5, when instructed to do so, the UE 501 reports the signal strength information of the cells 503, 505, 507, 509, 511 and 513. When viewing it from a perspective of each EN cell, the bands indicated within each cell (the bands indicated using a reference number followed by a ′ or ″ indicator, such as, for example, the band 503′ within the cell 503, the band 505′ within the cell 505, the band 507′ within the cell 507, the band 509′ within the cell 509, the bands 511′ and 511″ within the cell 511, and the bands 513′ and 513″ within the cell 513) identify potential locations where the UE 501 can actually be positioned within an associated cell when it is reporting the measurement information associated with a given cell. The present methods and apparatus for location based services for Enterprise Networks uses the combined information of all the cells measured by the UE 501 to accurately determine the UE's location within the EN campus.

More specifically, and referring again to FIG. 5, the center of the cell 511 is centrally located between the bands 511′ and 511″. The actual location of the UE can either be in one of the bands 511′ or 511″ due to the shape and configuration of the eNB (transmitter) that creates the cell 511 (because the cell 511 is formed using an outdoor Directional eNB). When the EN performs the UE location determination it must assume that the UE 501 may potentially be in either the band 511′ or 511″. One of these potential locations of the UE 501 must be eliminated when performing the UE location determination process. Moreover, when performing the trilateration techniques as described herein, the “x1, y1” coordinates of the UE must assume that they can exist in any of the “primed” bands indicated in FIG. 5 (for example, in the 503′ band for the cell 503, or the 507′ band for the cell 507, and so on). So the enhanced trilateration approach used to locate the UE 501 uses all of the potential “x1, y1” coordinates of the UE 501 (all of the “primed” band locations as shown in FIG. 5), and takes all of these potential UE x1, y1 coordinates into account when determining the UE's location. Therefore, the modified trilateration technique used by the present methods and apparatus determines the intersection of all of the potential x1, y1 coordinates for the UE 501 and uses that result to perform an enhanced trilateration of the UE 501. All of the potential x1, y1 locations of the UE are accounted for before performing a final enhanced trilateration process to determine the location of the UE 501. Essentially, the x1, y1 coordinates for the UE 501 is determined by the overlapping or intersection of the primed band areas (such as band 503′, 507′, 513′, 511′, etc.) in very much the same way that a Venn diagram determines overlapping subject matter.

In summary, the steps involved for performing “enhanced” trilateration on a UE operating within an EN having disparate cell types are as follows:
1. The UE reports the signal strength for the cells it measures;
2. Based on the cell type, the potential locations within each cell is determined accounting for the ranges based on the signal strength that is reported. This region within each cell also takes into consideration the potential error in the location identified for each eNB. The less the potential error is, the more accurate is the UE location determination;
3. Narrow the applicable region within each cell by identifying the geographic intersection regions for each cell relative to the regions identified for the other cells;
4. Determine the (xᵢ, yᵢ) coordinates that apply for each cell by using the middle of the intersecting region identified for each cell and
5. Use the (xᵢ, yᵢ) reported to determine the UE location using an enhanced version of the trilateration algorithm described herein.

### Exemplary OTDOA Techniques for Lbs in Enterprise Networks

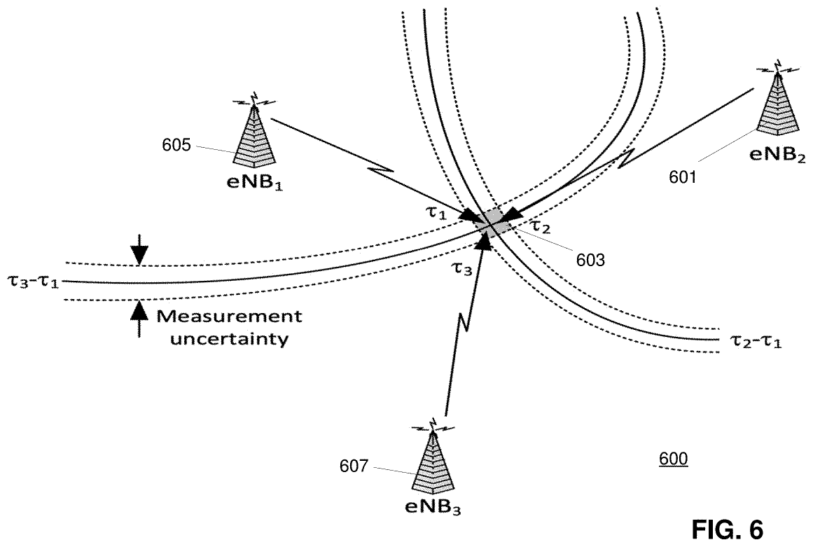

FIG. 6 shows an exemplary OTDOA technique in implementing LBS in Enterprise Networks. As described above, Observed Time Difference of Arrival (OTDOA) defines a time interval that is observed by a UE, such as the UE 603 of FIG. 6, between the reception of downlink signals from two different cells (or two different eNBs, such as eNB₁ 605 and eNB₂ 601. If a signal from cell 1 (from eNB₁ 605) is received at a moment t₁, and a signal from cell 2 (from eNB₂ 601) is received at a moment t₂ the OTDOA is t₂-t₁. Real Time Difference (RTD) defines the relative synchronization difference between two cells. If cell 1 (i.e., eNB₁ 605) transmits a signal at a moment t₃, and cell 2 (i.e., eNB₂ 601) transmits a signal at a moment t₄, the RTD is t₄-t₃. If the cells transmit at exactly the same time that means the communication network is perfectly synchronized and the RTDs are equal to zero. Geometric Time Difference (GTD) is the time difference between the reception (by a UE, such as the UE 603 of FIG. 6) of signals transmitted from two different cells (or two different eNBs wherein the time difference in reception is due to geometry). If the length of the propagation path between cell 1 (eNB₁ 605) and the UE 603 is d₁, and the length of the propagation path between cell 2 (eNB₂ 601) and the UE 603 is d₂, then GTD=(d₂-d₁)/c, where c is the speed of radio waves. The relationship between OTDOA, RTD and GTD is: OTDOA=RTD+GTD.

Referring again to FIG. 6, at least three timing measurements from geographically dispersed eNodeB's (or “eNBs”) with good geometry are needed to solve for the two coordinates (x, y or latitude/longitude) of the UE 603. In accordance with one embodiment of the OTDOA positioning method and as illustrated in FIG. 6, the UE 603 measures three time of arrivals (TOA's) relative to the UE 603 internal time base, π₁, π₂, and π₃. The measurement from eNB₁ 605 is selected as a reference base station, and two OTDOA's are formed: t_{2,1}=π₂−π₁ and t_{3,1}=π₃−π₁. Because each TOA measurement πᵢ has a certain accuracy/uncertainty, the hyperbolas are shown in FIG. 6 with a certain width, illustrating the measurement uncertainty. The estimated UE 603 location is the intersection area of the two hyperbolas (shown in FIG. 6 as a gray shaded area).

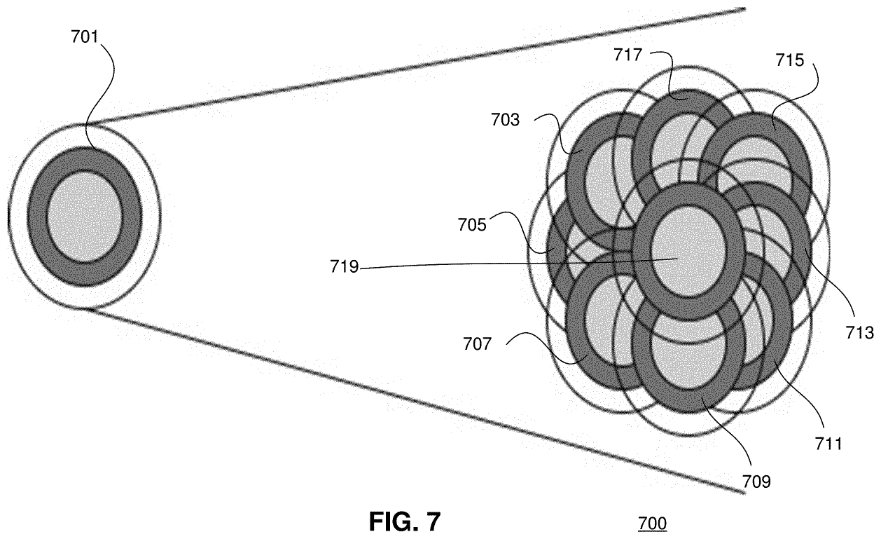

FIG. 7 is an illustration of a location estimation 700 of a CBSD (or EN eNB) deployed within an Enterprise Network (EN). As noted above, CBSDs (or EN eNBs) can be deployed within the EN network in a horizontal location within an accuracy of plus or minus 50 meters. Errors in the deployment of eNB locations (e.g., the locations of where the CBSDs (citizen band radio service devices) of the enterprise network are precisely located upon deployment) results in a degree of uncertainty regarding the actual location of the CBSD (EN eNB) 701. Therefore, the actual physical location of the EN eNB (or “CBSD”) 701 can exist in a myriad of horizontal locations (along the x-y axis) shown in FIG. 7. Stated differently, due to the potential plus or minus 50 meter location inaccuracies during deployment of the EN, and specifically during deployment of the EN eNB 701, the EN eNB 701 may be located at any of the locations shown in FIG. 7, such as for example, the location where the eNB 703 is shown in the figure. Similarly, due to inaccuracies during deployment of the eNB 701, the eNB 701 may actually be located where the eNBs 705, 707, 709, 711, 713, 715, 717 and 719 are shown to be located in FIG. 7.

The prior assumption for the trilateration algorithm described above assumes that the location of the EN eNB 701 is accurately identified. For the cell deployed in the CBSR band, FCC allows for a +/−50 meters error in the horizontal direction and +/=3 meters error in the vertical direction. FIG. 7 simply illustrates that although the cell is identified to be in a certain location, it is possible for it to be in any of the illustrated locations. The smaller the error in the EN eNB 701 location identification is, the more accurate the UE location determination is.

The UE measurement for OTDOA positioning is referred to as the Reference Signal Time Difference (RSTD) which is specified in 3GPP TS 36.214. The RSTD is defined as the relative timing difference between two cells, the reference cell, and a measured cell, and is calculated as the smallest time difference between two subframe boundaries received from two different cells. More specifically, RSTD is the relative timing difference between a neighbor cell j and the reference cell i, defined as T_{SubframeRxj}-T_{SubframeRxi}; wherein: T_{SubframeRxj} is the time when the UE 203 receives the start of one subframe from cell j, and wherein T_{SubframeRxi} is the time when the UE 203 receives the corresponding start of one subframe from cell i that is closest in time to the subframe received from cell j.

The RTSD measurements are possible on an intra-frequency cell and on an inter-frequency cell. An intra-frequency RSTD measurement is performed when both the reference cell i and the neighbor cell j are on the same carrier frequency as the UE serving cell. An inter-frequency RSTD measurement is performed when at least one of the reference cell i and the neighbor cell j is on a different carrier frequency as the UE serving cell.

The reporting range of the reference signal time difference (RSTD) measurement is defined from −15391×Ts to 15391×Ts with (3GPP TS 36.133). 1 Ts resolution for absolute value of RSTD less or equal to 4096 Ts and 5 Ts for absolute value of RSTD greater than 4096 Ts. Ts is the basic time unit in LTE is defined as Ts=1/(15000×2048) seconds, which is a little more than 32 ns corresponding to about 9.8 meters. Therefore, the full reporting range of the RSTD measurement is about ±0.5 ms (±15391×Ts) (i.e., one LTE subframe), with a 1 Ts reporting resolution if the measurement is between ±133 μs (4096×Ts).

### OTDOA Equations

In some embodiments, when performing OTDOA measurements the Time of Arrival (“TOA”) measurements performed by the UE are related to the geometric distance between the UE (such as, for example, the UE 603 of FIG. 6) and the eNB (such as, for example, eNB₁ 605 of FIG. 6). In a 2-D Cartesian coordinate system, the known coordinates of an eNB are represented as xᵢ=[xᵢ, yᵢ]^{T} and the unknown coordinates of the UE are presented as xₜ=[xₜ, yₜ]^{T}. The RSTD measurements are defined as the time difference between two eNodeB's (or between two eNBs)(modulo 1-subframe (1-ms)), and therefore, correspond to the following range differences between a neighbor eNB i and the reference eNB₁:

RSTD_{i,1}=(xₜ−xᵢ)²+(yₜ−yᵢ)²/_{c})−(xₜ−x₁)²+(yₜ−y₁)²/_{c})+(Tᵢ−T₁)+(nᵢ−n₁)

wherein: RSTD_{i,1} is the time difference between an eNB i and the reference cell 1 measured at the UE; (Tᵢ-T₁) is the transmit time offset between the two eNB's (referred to as “Real Time Differences” (RTDs)); nᵢ, n₁ are the UE TOA measurement errors, and c is the speed of light.

At least two neighbor cell measurements i are needed, which gives two equations with two unknowns (xₜ, yₜ) if the coordinates of the eNB antennas (xᵢ, yᵢ) as well as the transmit time offsets (RTDs) (Tⱼ−Tᵢ) are known. Usually, more than two neighbor cell measurements are desired. The system of equations is solved in the “least-squares”, or “weighted-least-squares” sense. In a synchronized network, the transmit time offsets (Tᵢ−T₁) should (ideally) be equal to zero. The equation set forth above defines the time-difference-of-arrival (TDOA). As noted above, and as shown in FIG. 6, geometrically, each TDOA defines a hyperbola, where the width of the hyperbola is determined by the TDOA errors (nᵢ−n₁). If the eNB coordinates xᵢ=[xᵢ, yᵢ]^{T} and the transmit time offsets (Tᵢ-T₁) are known at the location server, the UE coordinates xₜ=[xₜ, yₜ]^{T} can be determined. Any uncertainty in the eNB coordinates and transmit time offsets have a direct impact on the accuracy of the UE location estimates.

In some embodiments of the disclosed method and apparatus, and as described above, OTDOA information for trilateration is included. RSTD information, together with an estimate of the measurement quality, is reported for the pilot signals requested by the E-SMLC (such as, for example, the E-SMLC 113 of FIG. 1). In some embodiments of the present method and apparatus, the E-SMLC uses: (1) the time difference estimates; (2) knowledge of the position of the cells; and (3) estimates of transmit time offsets, to determine an estimate of the position of a UE. In some embodiments, the (xₜ, yₜ) of the UE (such as, for example, the UE 212 of FIG. 2A) are determined using weighted-least-squares providing more weight to the RSTD value reported by the UE 212. The distance r is based from each cell reported by the UE, wherein the unknown coordinates of the UE are xₜ=[xₜ, yₜ]^{T}. RTSD values are reported by the UE, wherein the values are relative to the serving cell. This is performed with CRS measurements alone or with PRS enabled as well.

In some embodiments, an estimate of the Z-axis (i.e., an estimation of the altitudinal location of the UE, or relative vertical location) can be attained using information regarding the floor level (i.e., the floor on which each CBSD resides). In some embodiments, floor level information is retained in the database. The floor level information can indicate a single floor or a set of floors, based on the footprint of coverage of the CBSD. In some embodiments, a finer estimate of the floor level can be attained by computing the relative distance based on signal strength to each of the measured CBSDs. Floor numbers implicitly provide a relative position of each level with respect to the other levels. In some embodiments, the vertical position of the floor (e.g., relative vertical location) can be retained in the database as well. In some embodiments, the vertical position is retained as a level relative to sea level.

In some embodiments, the indoor positioning is enhanced with Wi-Fi and BT based information. Beacon information can be made available within the enterprise campus and techniques developed for the UE to report the relevant information to an E-SMLC associated with the Enterprise deployment. In addition, or alternatively, the eNB/gNB is enhanced to support full ECID along with the AoA. Relevant algorithms are provided for calculating the vertical position.

In yet other embodiment, the floor level is determined based on which eNBs are reported by the UE. The signal strength of the eNB reports is ignored and the floor level where the eNBs are deployed is used without regard for the amount of power in the received signals. In some such embodiments, the UE may be closer to an eNB deployed on a floor above or below the UE, making the signal strength a “red herring”. Similarly, the cardinality of the eNBs in a given floor is ignored and is only used to break ties when needed. The UE will typically report pilots with the floor association (where x is the floor number associated with the serving eNB for the UE).

Where eNBs on two floors (x), (x+1) are reported, ties are broken based on a number of pilots reported at each given level. Where eNBs on two floors (x−1), (x) are reported, ties are broken based on a number of pilots reported at each given level. Where eNBs for three floors (x−1), (x), and (x+1) are reported, the floor in the middle is selected. Similarly, where eNBs for three floors (x), (x+1), (x+2) or (x−2), (x−1), (x) are reported, the floor in the middle is selected. If five eNBs (x−2), (x−1), (x), (x+1), (x+2) are reported, the floor in the middle is selected. In the case of four eNBs being reported, a tie between the two middle floors can be resolved similarly to the case in which only the two middle eNBs are reported.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for determining the location of user equipment (UE) in an enterprise communications network (EN), wherein the EN comprises at least one eNodeB (eNB), comprising:
a) a Mobile Management Entity (MME) in communications with the EN eNB via an S1-MME interface that allows signaling packets to be communicated between the EN eNB and the MME;
b) an Evolved Serving Mobile Location Center (E-SMLC) in communication with the MME, wherein the E-SMLC provides data packets to be communicated between the E-SMLC and the EN eNB, and wherein the E-SMLC generates Measurement Request Messages (MRMs) for transmission to the EN eNB, and wherein the MRMs instruct the EN eNB to obtain measurements from the UE when the UE operates within the EN communications network, and wherein the measurements are used to determine positioning location information of the UE; and
c) a Gateway Mobile Location Center (GMLC) coupled to the MME, wherein the GMLC receives packets from the MME that include information regarding the location of the EN eNB and measurements provided by the EN eNB to the MME; wherein the EN eNB transmits the positioning location information of the UE to the MME and to the E-SMLC using an LPPa communications protocol.

2. The system for determining the location of user equipment (UE) in an enterprise communications network (EN) of claim 1, wherein the LPPa communications protocol is enhanced to include GPS coordinate locations of the EN eNB.

3. The system for determining the location of user equipment (UE) in an enterprise communications network (EN) of claim 1, wherein the positioning location information of the UE is determined using a Secure User Plane Location (SUPL) architecture for mobile devices in a wireless network.

4. The system for determining the location of user equipment (UE) in an enterprise communications network (EN) of claim 3, wherein the SUPL architecture comprises a User plane communications protocol.

5. The system for determining the location of user equipment (UE) in an enterprise communications network (EN) of claim 1, wherein the LPPa communications protocol is modified to accommodate the transmission of EN-specific contextual information in addition to GPS coordinate information of the UE.

6. The system for determining the location of user equipment (UE) in an enterprise communications network (EN) of claim 5, wherein assisted-GPS information is transmitted via the LPPa communications protocol.

7. The system for determining the location of user equipment (UE) in an enterprise communications network (EN) of claim 1, wherein the positioning location information of the UE is determined by the EN locally, and wherein the EN performs enhanced trilateration of UEs operating within the EN.

8. The system for determining the location of user equipment (UE) in an enterprise communications network (EN) of claim 5, wherein the EN-specific contextual information includes information about cells operating within the EN.

9. The system for determining the location of user equipment (UE) in an enterprise communications network (EN) of claim 8, wherein the of EN-specific contextual information includes information regarding the type of cells operating within the EN, the sizes of the cells operating within the EN, and the radio signal transmission power produced by the cells.

10. The system for determining the location of user equipment (UE) in an enterprise communications network (EN) of claim 9, wherein the cells operating within the EN have RF footprints of different sizes and shapes.

11. The system for determining the location of user equipment (UE) in an enterprise communications network (EN) of claim 7, wherein the EN uses inherent knowledge regarding the different types of EN cells deployed within the EN when performing the UE positioning determination.

12. The system for determining the location of user equipment (UE) in an enterprise communications network (EN) of claim 7, wherein the EN accounts for errors in EN eNB deployments, inaccuracies in eNB positioning, and other EN cell characteristics when performing the UE positioning determination.
